(19) United States
(12) Patent Application Publication
(10) Pub. No.: US 2025/0368885 A1
(43) Pub. Date: Dec. 4, 2025

(54) FILTER CAKE REMOVAL USING VISCOELASTIC SURFACTANT

(71) Applicant: Saudi Arabian Oil Company, Dhahran (SA)

(72) Inventors: Katherine Leigh Hull, Houston, TX (US); Amy J. Cairns, Houston, TX (US); Rajesh Kumar Saini, Cypress, TX (US); Brady Kevin Crane, Houston, TX (US)

(21) Appl. No.: 18/732,298

(22) Filed: Jun. 3, 2024

(51) Int. Cl. C09K 8/524; C09K 8/528; C09K 8/536

(52) U.S. Cl. CPC C09K 8/524; C09K 8/528; C09K 8/536; C09K 2208/26; C09K 2208/30

(57) ABSTRACT

A method of treating a wellbore for filter cake removal, the method comprising: injecting a reactive treatment fluid into a wellbore in a subterranean formation comprising a filter cake on a wall of the wellbore, the filter cake comprising an oil, a water-resistant polymer, a barite, and an inorganic salt, the reactive treatment fluid comprising, a viscoelastic surfactant (VES), a reactive breaker comprising an oxidizing salt, and an acid-generating material; and contacting the reactive treatment fluid with the filter cake in the wellbore, the reactive treatment fluid dissolving or exfoliating the barite from the wall into the reactive treatment fluid.

### TECHNICAL FIELD

This disclosure relates to methods of filter cake removal using a reactive treatment fluid including a viscoelastic surfactant.

### BACKGROUND

Drilling fluid, or drilling mud, aides the drilling of holes into a subterranean formation in the Earth's crust. The holes, called boreholes or wellbores, are typically drilled for the exploration or production of crude oil and natural gas, but can be drilled for other applications, such as for a water well. During the drilling, the drilling fluid cools and lubricates the drill bit and also carries and removes rock cuttings from the hole. The drilling fluid also provides hydrostatic pressure to prevent or reduce formation fluids from the subterranean formation entering into the hole during drilling. Drilling fluids, or treatment fluids more generally, include completion fluids, workover fluids, drill-in fluids, and so on.

Drilling fluids are typically mixtures of solid additives present as discontinuous phases spread in a liquid continuous phase. The liquid is water in the case of the water-based drilling fluids (WBDF) or oil for the oil-based drilling fluids (OBDF). As indicated, the drilling fluids may be designed to achieve different operational objectives including lubrication of the drill bit and drill string, transferring the drilled cuttings out of the hole while drilling, and suspending cuttings when the fluid circulation is stopped. Another objective may be to prevent the formation fluids from invading the wellbore hole. In the drilling operation with the drilling fluid, wellbore stability may be promoted by forming a low-permeability film on the borehole wall labeled as filter cake, also called cake, mudcake, or wall cake. The filter cake may also reduce drilling fluid invasion into the drilled formation. Once the process of drilling is complete, the filter cake must be removed before production operations to prevent flow capacity issues and enhance injectivity through injection wells. However, some portions of the filter cake can be difficult to remove due to its stable chemical nature, e.g., low solubility of inorganic salts, or location, e.g., incomplete removal at an end portion of the wellbore.

### SUMMARY

This disclosure describes technologies relating to methods of filter cake removal, more specifically to compositions of reactive treatment fluid that can effectively attack the components in oil-based drilling fluid (OBDF)-derived filter cake.

### BRIEF DESCRIPTION OF DRAWINGS

FIG. 1 is a diagram of a well having a wellbore formed through the Earth surface into a subterranean formation.

FIG. 2 is a diagram of a well system having a wellbore formed through the Earth surface into a geological formation in the Earth crust.

FIG. 3 is a diagram of a well having a filter cake.

FIGS. 4A-4C are diagrams of a sequence of particle buildup of filter cake on the surface of the subterranean formation in a wellbore.

FIGS. 5A-5C are example chemical structures of zwitterionic surfactants for a viscoelastic surfactant (VES) for a reactive treatment fluid.

FIGS. 6A-6C are example chemical structures of cationic surfactants for a viscoelastic surfactant (VES) for a reactive treatment fluid.

FIGS. 7A-7C are example chemical structures of anionic surfactants for a viscoelastic surfactant (VES) for a reactive treatment fluid.

FIGS. 8A-8B are example chemical structures of nonionic surfactants for a viscoelastic surfactant (VES) for a reactive treatment fluid.

FIG. 9 is a process flow diagram of the process of filter cake removal.

FIGS. 10-11 are photographs of test tubes before and after dissolution tests using a VES-based reactive treatment fluid.

FIG. 12 is a plot of rheological profiles for a VES-based reactive treatment fluid as a function of temperature.

FIG. 13 is a plot of pH for a VES-based reactive treatment fluid after a heat treatment.

### DETAILED DESCRIPTION

Implementations described herein provide the methods of removing filter cake from a wellbore in a subterranean formation using a reactive treatment fluid containing a viscoelastic surfactant (VES), a reactive breaker, and an acid-generating material. In various implementations, the reactive treatment fluid compositions can be particularly effective in removing oil-based filter cake, which is derived from oil-based drilling fluids (OBDF). Generally, drilling fluids, whether water-based or oil-based, consist of solid additives dispersed in a liquid phase, serving various operational objectives such as lubricating the drill bit, transporting drilled cuttings, and maintaining wellbore stability. During drilling, a filter cake forms on the borehole wall, aiding wellbore stability and reducing fluid invasion into the formation. However, before production operations, this filter cake must be removed to prevent flow capacity issues and ensure injectivity through injection wells.

OBDF primarily consist of insoluble materials such as barite, constituting approximately 80% of the weight of the OBDF, with most of the remaining OBDF (approximately 10⁻¹⁵%) comprising polymer compounds. Cleaning up the oil-based filter cake formed during drilling often involves solvent-based treatments to disperse the oil and solid particles. However, the complexity in filter cake compositions requires the reactive treatment fluid to have multiple functionalities. For example, inorganic salts and polymeric components in the filter cake generally need to be attacked by different chemistries. Particularly, it is challenging to remove barite, often used as inorganic weighting materials in the OBDF and coated by oil and polymers in the oil-based filter cake. Further, addressing long horizontal sections of the wellbore during treatment can also be difficult because reactive treatment fluids may be spent near the heel of the well, affecting their efficiency along the lateral length.

In various implementations, the reactive treatment fluid described in this disclosure uses a VES and an oxidizing salt as a reactive breaker. The VES can gel the reactive treatment fluid to provide a VES gel, which is useful in retaining the oxidizing salt and delivering it to an end portion of a horizontal portion of the wellbore. The reactive breaker primarily degrades the polymeric materials in the oil-based filter cake. In addition, reactive treatment fluid can contain an acid-generating material that is neutral during mixing on the surface and pumping. It can form acid via heat from the subterranean formation or pH trigger to attack weighting agent in the filter cake, e.g., some inorganic salts such as calcium carbonate (CaCO₃) while the acid also can lower the viscosity of the VES gel. In some implementations, the injection of the reactive treatment fluid is combined or alternated with the injection of another treatment fluid, e.g., a fluid containing carbon dioxide (CO₂) to enhance the filter cake removal efficiency.

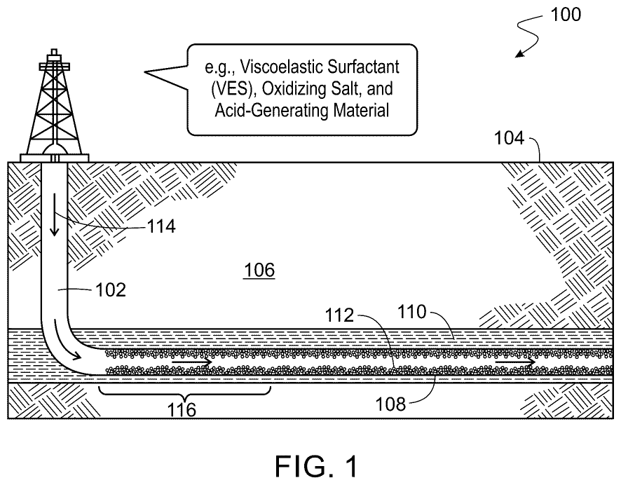

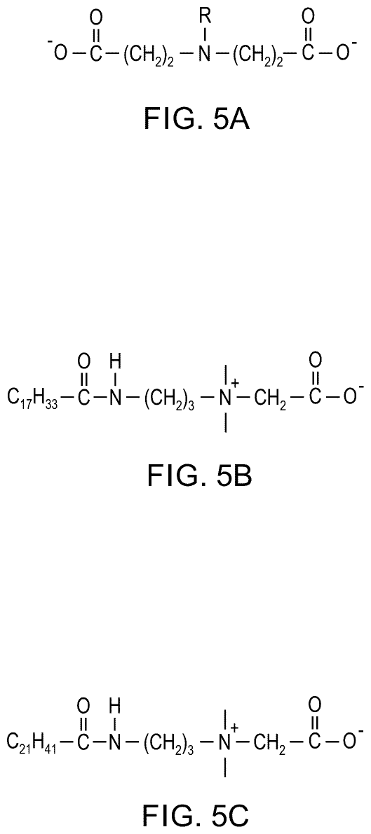

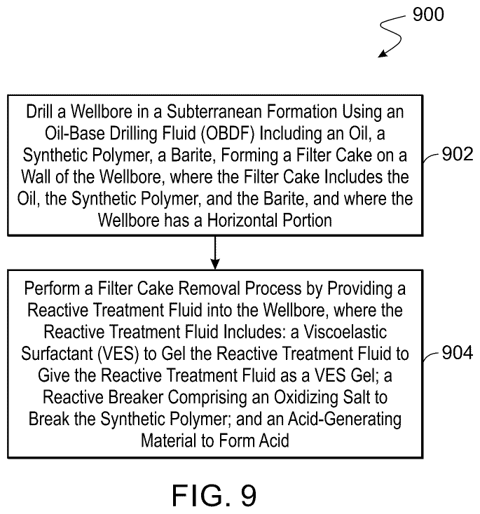

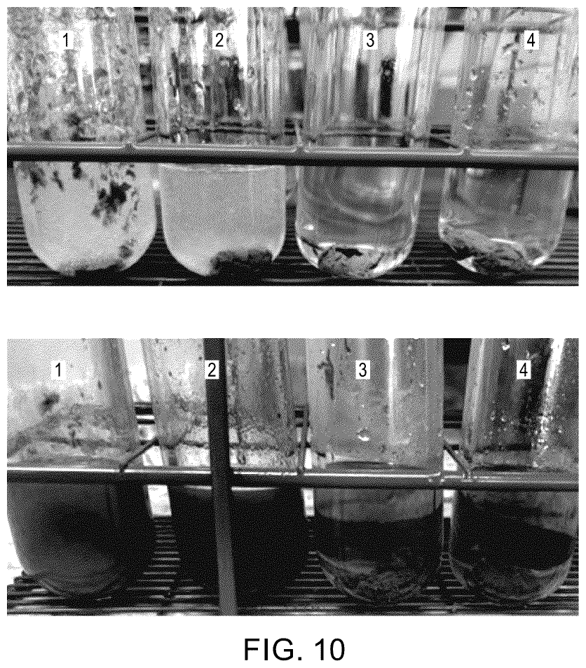

In the following, the overview of the filter cake formation and removal is first provided referring to FIGS. 1-3 and 4A-4C. The compositions of VES-based reactive treatment fluid in various implementations are then described referring to FIGS. 5A-5C, 6A-6C, 7A-7C, and 8A-8B. FIG. 9 is an example process flow diagram for the filter cake removal process. Experimental results of filter cake dissolution using the VES-based reactive treatment fluid in accordance with some implementation are described referring to FIGS. 10-13. In this disclosure, the filter cake “removal” can include permeability enhancement of the filter cake. It should also be understood that “VES-based fluid” generally contains more than a VES. Further, a VES-based fluid can include water as a base fluid.

### Filter Cake Formation and Removal

FIG. 1 is a diagram of a well 100 having a wellbore 102 formed through the Earth surface 104 into a subterranean formation 106. The wellbore 102 has a horizontal portion 108 in a hydrocarbon reservoir section 110 of the subterranean formation 106. The wellbore 102 has a filter cake 112 on a wall of the wellbore 102. As further described below, the filter cake 112 can be formed because of the drilling of the well 100. A treatment fluid 114 is injected into the wellbore 102 to remove the filter cake 112. In a conventional method, the treatment fluid 114 can use acid, such as hydrochloric acid, where the acid may be spent quickly and thus may only treat and remove the filter cake 112 in a small section 116 of the wellbore 102. In various implementations, the VES-based reactive treatment fluid can be tuned to have a desired rheology and functionality, e.g., acidity, such that the treatment fluid 114 can reach the end portion of the long horizontal portion of the wellbore 102.

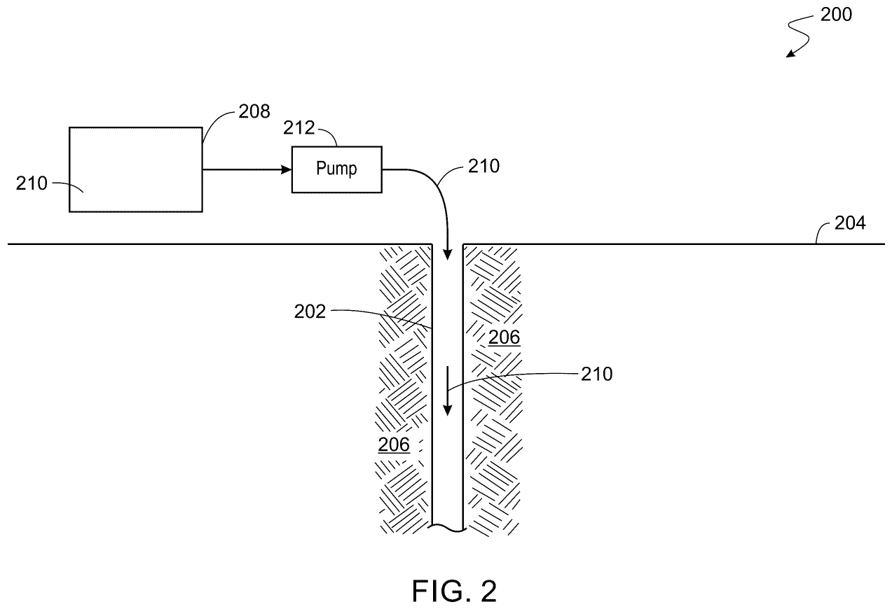

FIG. 2 is a diagram of a well system 200 having a wellbore 202 formed through the Earth surface 204 into a geological formation 206 in the Earth crust. The subterranean formation 206 can be labeled as a geological formation, a rock formation, or a hydrocarbon formation.

The wellbore 202 can be vertical, horizontal, or deviated. The wellbore 202 can be openhole but is generally a cased wellbore. The annulus between the casing and the subterranean formation 206 can be cemented. Perforations can be formed through the casing and cement into the subterranean formation 206. The perforations may allow both for flow of fracturing fluid into the subterranean formation 206 and for flow of produced hydrocarbon from the subterranean formation 206 into the wellbore 202.

The well site 200 may have a drilling system including a source 208 of a drilling fluid 210 at the Earth surface 204 near or adjacent the wellbore 202. The source 208 can include one or more vessels holding the drilling fluid 210. The drilling fluid 210 may be stored in vessels or containers on ground, on a vehicle, e.g., truck or trailer, or skid-mounted. In various implementations, the drilling fluid 210 is an oil-based fluid.

In various implementations, the drilling fluid 210 contains diesel oil or palm oil as a base fluid. Further the drilling fluid 210 can contain a water-resistant polymer such as ethylene-propylene polymer, maleated polymer, organophilic clay, and poly-a-olefins. In some implementations, the water-resistant polymer is used as a rheology modifier, e.g., viscosifier. The drilling fluid 210 can also contain a weighting agent and other additives, e.g., emulsifier, wetting agent, biocide, defoamer, and lubricant. The weighting agent can include various inorganic salts such as calcium carbonate, bentonite, barite, ilmenite, hematite, and manganese tetroxide.

The well system 200 can include motive devices such as one or more pumps 212 to pump the drilling fluid 210 through the wellbore 202 into the subterranean formation 206. The pumps 212 can be, for example, positive displacement pumps and arranged in series or parallel.

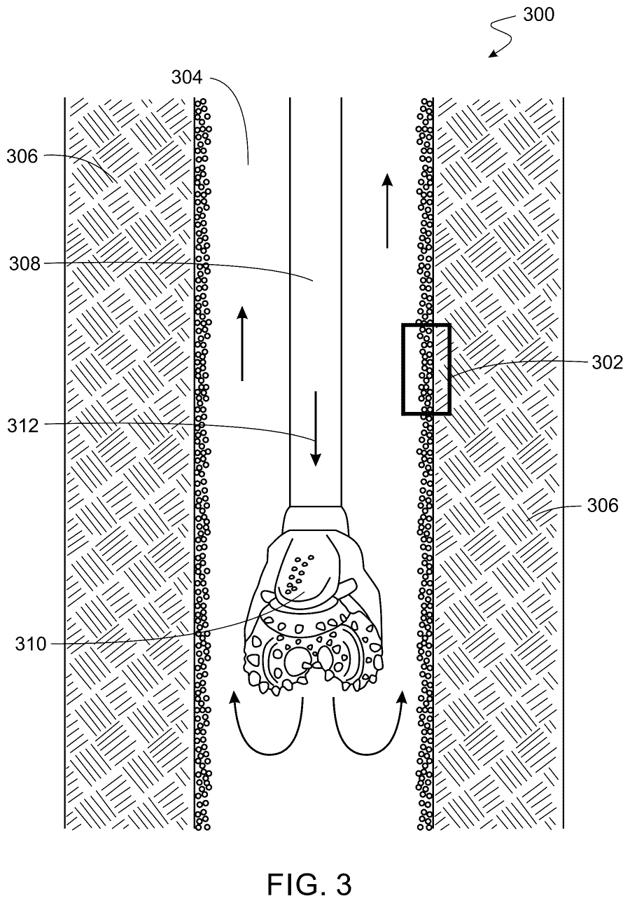

FIG. 3 is a diagram of a well 300 having a filter cake 302. The well 300 includes a wellbore 304 formed in a subterranean formation 306. The face of the formation 306 is formed by drilling is the wellbore 304 wall. A drill string 308 and drill bit 310 are disposed in the wellbore 304. In the drilling operation, drilling fluid 312 is injected into the drill string 308. The drilling fluid 312 can be pumped, for example, with mud pumps from the Earth surface into the drill string 308 in the wellbore 302.

The well site of the well 300 can include surface equipment, such as a mounted drilling rig, piping, storage tanks, and so on, at the Earth surface. The surface equipment may include the aforementioned mud pumps that can be, for example, centrifugal pumps, positive displacement pumps, reciprocating pumps, or piston pumps.

The wellbore 304 diameter can be, for example, in a range from about 3.5 inches (8.9 centimeters) to 30 inches (76 centimeters), or outside of this range. The depth of the 302 can range from 300 feet (100 meters) to more than 30,000 feet (9,100 meters). The wellbore 304 can be vertical, horizontal, or deviated, or any combinations thereof. Once the wellbore 302 is drilled, the wellbore 302 may be completed.

To form a hole in the ground, the drill bit 310 with cutters can be lowered into the wellbore 304 and rotated to break the formation rock. In the rotation, the cutters may interface with the formation 306 to grind, cut, scrape, shear, crush, or fracture rock to drill the hole. The drill bit 310 can be a component of the drill string 308 or coupled to the drill string 308. The drill bit 310 can be lowered via the drill string 308 into the wellbore 304 (borehole) to drill the wellbore 304 into the subterranean formation 306 in the Earth crust. In operation, the drilling fluid 310, also known as drilling mud, is circulated down the drill string 308 and through multiple nozzles in the drill bit 310 to the bottom of the wellbore 304. The drilling fluid 312 may then flow upward towards the surface through an annulus between the drill string 310 and the wall of the wellbore 304. The drilling fluid 312 may cool the drill bit 310, apply hydrostatic pressure upon the formation 306 penetrated by the wellbore 304 to prevent or reduce fluids from flowing into the wellbore 302, reduce the torque and the drag force induced by the friction between the drill string 308 and the wellbore 304 wall, carry the formation cuttings up to the surface, and so forth.

The filter cake 302 can be formed via the circulating drilling fluid 312. Solids from the drilling fluid 312 can build on the surface of the formation 306, which is the wall of the wellbore 304, as the filter cake 302. In some implementations, the filter cake 302 form as solids of the drilling fluid 312 slurry deposit on permeable portions of the formation 306 face under wellbore 304 pressure. Initially, as the filter cake 302 is being deposited on the surface of the permeable material, the material firstly serves as a filter and allows the liquid portions, e.g., filtrate, of the drilling fluid 312 to pass through and trapping the insoluble solid portion as a cake. Over time, enough filter cake gathers on the surface of the permeable material, allowing little or no further liquid invasion. The drilling fluid 312 can be configured for formation of the filter cake 302. This filter cake 302 may be deposited on the porous rocks under overbalance pressure conditions. The formation of filter cake 312 can advantageously prevent or reduce further loss of drilling fluid 312 into the formation 306 and reduce solid invasion as well. In other words, the filter cake 312 can help prevent loss circulation and formation damage that would be caused by fines and filtrate invasion into reservoir rocks. A filter cake 302 that is relative thin and with low permeability may generally be desirable.

In some implementations, the filter cake 302 has a thickness from 0.5 mm to 3 mm, e.g., 1 mm to 3 mm or 0.5 mm to 2 mm. In some implementations, the filter cake 302 has a permeability from 0.001 millidarcy (md) (9.87×10⁻¹⁹ m²) to 0.1 millidarcy (md) (9.87×10⁻¹⁷ m²), e.g., from 0.01 millidarcy (md) (9.87×10⁻¹⁸ m²) to 0.1 millidarcy (md) (9.87×10⁻¹⁷ m²), or from 0.001 millidarcy (md) (9.87×10⁻¹⁹ m²) to 0.01 millidarcy (md) (9.87×10⁻¹⁸ m²).

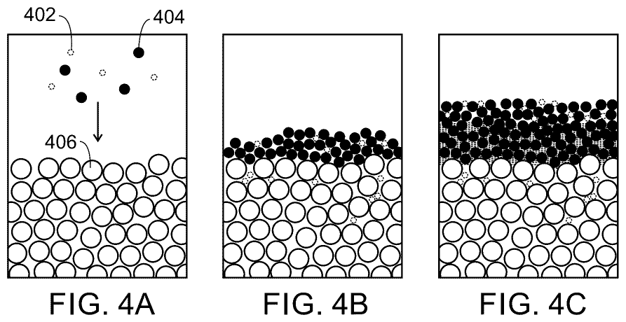

FIGS. 4A-4C are diagrams of a sequence of particle buildup of filter cake on the surface of the subterranean formation in a wellbore. As illustrated in FIGS. 4A-4C, particles 402, 404 signify solid components of the drilling fluid formulation. The circles 406 signify the granular porous nature of the subterranean rock formation, where some of the filter cake can invade into the formation. In FIG. 4A, the particles 402, 404 in the drilling fluid are depicted flowing toward the formation, as indicated by an arrow. In FIG. 4B, in the time sequence later in time, the particles 402, 404 accumulate on the formation face, which includes the wellbore wall, forming the filter cake. In some implementations, as illustrated in FIG. 4B, some of the smaller particles 402 may invade into the formation. FIG. 4C illustrates the time sequence is later in which the filter cake may be considered formed. The filter cake may be characterized as the collection of particles 402, 404 at the formation face. The build of the particles 402, 404 including the dense accumulation of the smaller particles 402 may desirably provide for low permeability of the filter cake.

After the drilling process, a filter cake removal process can be performed prior to further well operations. However, the complexity of the filter cake compositions may pose challenges in its removal. Since the filter cake is formed during the drilling process, the filter cake can include various materials such as oil, polymers, and inorganic salts derived from the drilling fluid, e.g., OBDF.

In various implementations, the VES-based reactive treatment fluid is specifically tailored to attack an oil-based filter cake. Such an oil-based filter cake can contain oils, e.g., diesel oil or palm oil, a water-resistant polymer such as ethylene-propylene polymer, maleated polymer, organophilic clay, and poly-a-olefins. Further, the oil-based filter cake can include various inorganic salts such as calcium carbonate, bentonite, barite, ilmenite, hematite, and manganese tetroxide.

One challenge in effectively removing the oil-based filter cake is that the polymer in the filter cake, e.g., 10⁻¹⁵ wt. % of the filter cake, may not degrade in the same treatment fluid designed for the weighting material. Acid, for example, can dissolve calcium carbonate but generally not polymer. Also, additives for breaking the polymer are often not compatible with the treating fluid. Further, the deposition of the filter cake may be heterogeneous. For example, in one implementation, the polymer is the predominant component of the top layer of the filter cake. In this case, the polymer may need to be penetrated by the treatment fluid in order to treat the remainder of the filter cake. In some implementations, particulates of the inorganic salts, e.g., barite, are coated by the oil, the polymeric materials, or both, which makes the removal more difficult. In various implementations, the VES-based reactive treatment fluid of this disclosure can overcome these issues by effectively dissolving or exfoliating different components of the filter cake in the wellbore.

### Viscoelastic Surfactant (VES) for Reactive Treatment Fluid

The VES-based reactive treatment fluid can be an aqueous solution containing one or more VES. The VES can induce a gelation of the reactive treatment fluid to provide a VES gel. In various implementations, the VES concentration in the base fluid, e.g., water, is between about 1 volume percent (vol. %) and about 15 vol. %, for example, between about 2 vol. % and about 8 vol. %, depending on the temperature and viscosity requirement. For example, the VES concentration can be between about 2 vol. % and about 6 vol. %, about 4 vol. % and about 6 vol. %, or about 2 vol. % and about 4 vol. %. In other implementations, the VES concentration is in a range of about 0.1 weight percent (wt. %) to about 10 wt. % or in a range of about 0.5 wt. % to about 7 wt. %, or at least 1 wt. %. For example, the VES concentration can be between about 1 wt. % and about 7 wt. %, about 1 wt. % and about 5 wt. %, or about 3 wt. % and about 5 wt. %. The VES can include a zwitterionic or amphoteric surfactant, a cationic surfactant, an anionic surfactant, a nonionic surfactant, or a combination of cationic and anionic surfactants. The base fluid for the reactive treatment fluid can be fresh water, seawater, produced water, treated water, or a combination thereof.

The zwitterionic surfactant can be a betaine, phosphobetaine, or sultaines. The zwitterionic surfactant can include dihydroxyl alkyl glycinate, alkyl ampho acetate or propionate, alkyl amidoamine oxide, gemini VES, alkyl betaine, alkyl amidopropyl betaine, and alkylimino mono- or di-propionates derived from waxes, fats, or oils. FIGS. 5A-5C are example chemical structures of zwitterionic surfactants for a VES for a reactive treatment fluid: disodium tallowiminodipropionate (FIG. 5A), disodium oleamidopropyl betaine (FIG. 5B), and erucylamidopropyl betaine (FIG. 5C). In FIG. 5A, R=tallow.

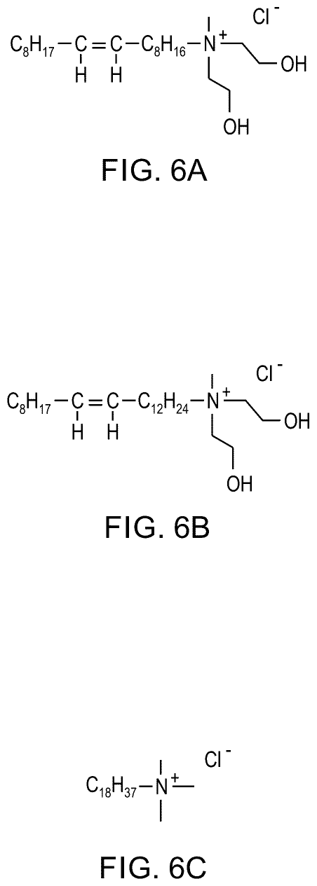

For cationic surfactants, examples include alkylammonium salts. FIGS. 6A-6C are example chemical structures of such salts: oleyl methyl bis(2-hydroxyethyl) ammonium chloride (FIG. 6A), erucyl bis(2-hydroxylethyl)methylammonium chloride (FIG. 6B), and N,N,N, trimethyl-1-octadecammonium chloride (FIG. 6C). Other alkylammonium salts as the cationic surfactant can include cetyltrimethylammonium bromide (CTAB) or dimethylene-1,2-bis(dodecyldimethylammonium bromide). The cationic surfactant can be associated with inorganic anions, such as sulfate, nitrate, and halide. The cationic surfactant can be associated with organic anions, such as salicylate, functionalized sulfonates, chlorobenzoates, phenates, picolinates, and acetates. The cationic surfactant can alternatively be associated with an oxidizing anion, such as chlorate, bromate, perchlorate, chlorite, hypochlorite, persulfate, iodate, bromite, hypobromite, perborate, dichromate, permanganate, ferrate, percarbonate, nitrite, and nitrate.

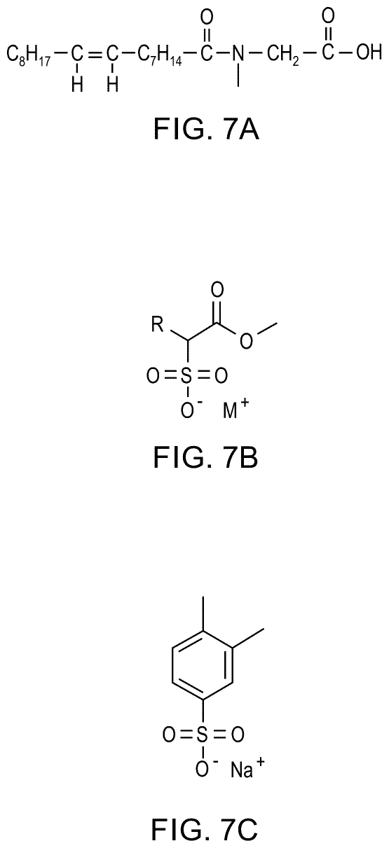

Examples of anionic surfactants include alkyl sarcosinates or sulfonates. FIGS. 7A-7C are example chemical structures of anionic surfactants. FIG. 7A illustrates oleoyl sarcosine as an example of an alkyl sarcosinate. In some implementations, the oleoyl sarcosine constitutes about 94% of the sarcosinate product. FIGS. 7B and 7C illustrate methyl ester sulfonate and sodium xylene sulfonate, respectively, as examples of sulfonates. In FIG. 7B, R is an alkyl chain with 10⁻³⁰ carbon atoms.

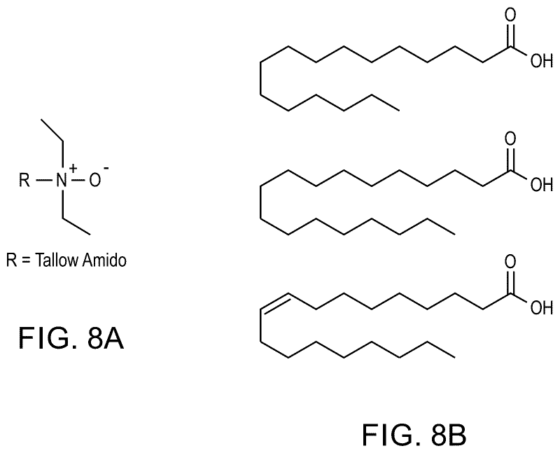

Examples of nonionic surfactants include amine oxides. FIGS. 8A and 8B illustrates tallow amido propylamide oxide (TAPAO) and three major components of the tallow amido substituent, respectively.

In one implementation, the VES components for the reactive treatment fluid can include a combination of cationic and anionic surfactants, e.g., N,N,N-trimethyl-1-octadecammonium chloride and sodium xylene sulfonate, where the total surfactant concentration ranges from about 0.1 wt. % to about 10 wt. %, e.g., about 0.5 wt. % to about 7 wt. %. For example, the total surfactant concentration can be between about 1 wt. % and about 7 wt. %, about 1 wt. % and about 5 wt. %, or about 3 wt. % and about 5 wt. %.

### Oxidizing Salt for Reactive Treatment Fluid

In various implementations, the VES-based reactive treatment fluid contains a reactive breaker such as an oxidizing salt. The reactive breaker can break a water-resistant polymer in the filter cake. The concentration of the oxidizing salt in the reactive treatment fluid can be in a range of about 1 wt. % to about 20 wt. % or in a range of about 1 wt. % to about 10 wt. %. In some implementations, the concentration is at least 3 wt. %, at least 5 wt. %, at least 7 wt. %, or at least 10 wt. %. In some implementations, the reactive breaker even at high concentration, e.g., saturated in the treatment fluid, does not affect the gelling performance of the VES, but may break polymer upon exposure. By utilizing a gel, some of the oxidizing salt in the treatment fluid can extend across the horizontal section of the wellbore. The oxidizing salt as the breaker may be at or below saturated conditions in the reactive treatment fluid. The oxidizing salt can exceed saturation. The concentration of the oxidizing salt can be in excess of that to break the polymer. The concentration of the oxidizing salt in the reactive treatment fluid may be specified based on the thickness of the filter cake and the particular well or section of the wellbore.

In various implementations, the reactive breaker can attack and degrade organic materials in the geological formation. The oxidizing salts are generally inert to oxidation. Examples of the oxidizing salt include lithium chlorate (LiClO₃), sodium chlorate (NaClO₃), potassium chlorate (KClO₃), magnesium chlorate [Mg(ClO₃)₂], calcium chlorate [Ca(ClO₃)₂], strontium chlorate [Sr(ClO₃)₂], barium chlorate [Ba(ClO₃)₂], lithium bromate (LiBrO₃), sodium bromate (NaBrO₃), potassium bromate (KbrO₃), magnesium bromate [Mg(BrO₃)₂], calcium bromate [Ca(BrO₃)₂], strontium bromate [Sr(BrO₃)₂], and barium bromate [Ba(BrO₃)₂]. Other oxidizers that can be used include magnesium peroxide, calcium peroxide, sodium nitrate, sodium nitrite, sodium persulfate, potassium persulfate, sodium tetraborate, sodium percarbonate, sodium hypochlorite, an iodate salt, a periodate salt, a dichromate salt, a chlorite salt, a hypochlorite salt, and a permanganate salt. The iodate salt may be a salt of IO₃⁻ with lithium, sodium, potassium, or magnesium, among others. Hydrogen peroxide as an oxidizer can also be used.

In addition to provide the ability to degrade the polymeric materials and others in the filter cake, the inorganic oxidizer salts promote formation of micelles, such as cylindrical or worm-like micelles, to increase viscosity of the reactive treatment fluid.

### Acid-Generating Material for Reactive Treatment Fluid

Further, the reactive treatment fluid can contain an acid-generating material that is neutral during mixing at Earth surface and during initial pumping into the wellbore. The generated acid can dissolve the inorganic salt in the filter cake. In some implementations, heat can be used as a trigger for acid generation. For example, once the treatment fluid increases in temperature in the wellbore due to heat provided by the subterranean formation, acid may be generated by the acid-generating material. Other triggers may also cause the reaction to occur that results in acid formation such as pH change. The acid may lower the viscosity of the gel. The acid may dissolve weighting material, e.g., calcium carbonate, of the filter cake.

Multiple techniques can be employed to generate acid in situ. A wide range of acids can be produced depending on the technique. In some implementations, an acid generated is hydrochloric acid. The generation of the acid can thus involve liberation of hydrogen ions or hydrogen chloride.

A first technique for acid generation is the use of degradable polymeric materials. The solid acid-generating material can degrade over time, e.g., due to formation temperature, to generate acid. Examples of degradable polymeric materials include polylactic acid (PLA), also known as polylactide, polyglycolic acid (PGA), an orthoester, or a polyanhydride, or any combinations thereof.

The size of the particles can be, for example, in ranges of about 20 microns (μm) to about 2 mm, about 100 microns to about 1 mm, about 100 microns to about 500 microns, about 125 microns to about 400 microns, or about 150 microns to about 200 microns. In some implementations, the particular solid acid-generating material is selected at least in part on the formation temperature or well temperature. For instance, in some implementations, PLA is used for wells have higher temperature, e.g., at least about 200° F. (93° C.) or in a range of about 200° F. (93° C.) to about 350° F. (177° C.). In another example, PGA may be utilized for wells with lower temperature, such as less than about 200° F. (about 93° C.) or in a range of about 140° F. (60° C.) to about 200° F. (93° C.).

A second technique to generate acid in situ is to incorporate an ester as the acid-generating material into the reactive treatment fluid. As the reactive treatment fluid is applied to the wellbore, the esters may hydrolyze over time to generate acid including due to temperature of the subterranean formation or wellbore. The esters can be, for example, of carboxylic acid. Fast degrading esters can be utilized for wellbores in subterranean formations having lower temperatures such as less than about 200° F. (about 93° C.) or in a range of about 140° F. (60° C.) to about 200° F. (93° C.). In contrast, slow hydrolyzing esters may be utilized for wellbores in subterranean formations having higher temperatures, e.g., at least about 200° F. (93° C.).

A third technique to generate acid in situ is to use ammonium salt as the acid-generating material to the reactive treatment fluid, where an acid is formed by the oxidation of the ammonium salt. In various implementations, the oxidation can be induced by an oxidizing salt present in the reactive treatment fluid. In some implementations, the oxidizing salt is the same oxidizing salt as the reactive breaker as described above. If so, the oxidizing salt in this acid generation can be excess oxidizing salt from the polymer breaking. This oxidizing salt may also be in excess to that needed to react with the ammonium for acid generation. In other implementations, the oxidizing salt can be different than the oxidizing salt that is the reactive breaker. The oxidizing salt may be a second oxidizing salt in addition to the oxidizing salt as the reactive breaker that breaks the polymer in the filter cake.

The type of acid that can be generated can depend on the anion of the ammonium salt. For example, citric acid can be generated from the oxidation of ammonium citrate, sulfonic acid from sulfonate, and sulfuric acid from sulfate. The length of an induction time prior to acid being generated can be controlled by the counteranion with the ammonium salt or by addition of nonoxidizing salts. In some embodiments, addition of lithium-based salts may delay the formation of acid. In some embodiments, addition of bromide-based salts may delay the formation of acid.

Examples of the ammonium salt include ammonium halide, e.g., ammonium fluoride, ammonium chloride, ammonium bromide, ammonium iodide, and mixtures thereof. In some implementations, the ammonium salt can include an anion that is also an oxidizing agent. For instance, the ammonium salt can include ammonium persulfate. Further, the ammonium salt can include a polyatomic anion such as sulfate, hydrogen sulfate, thiosulfate, nitrite, nitrate, phosphite, phosphate, monohydrogen phosphate, dihydrogen phosphate, carbonate, and combinations thereof.

In some implementations, the ammonium salt includes an N-substituted ammonium salt, e.g., mono-substituted, di-substituted with one or two alkyl groups, or tri-substituted with three alkyl groups. Examples of the alkyl groups include methyl, ethyl, propyl, and butyl. In some implementation, the ammonium salt is not a tri-substituted ammonium salt or a tetra-substituted ammonium salt.

Other examples of the ammonium salt include ammonium alkylsulfonates, ammonium arylsulfonates, ammonium alkarylsulfonates, or any combinations thereof. Further, the ammonium salt can include substituted, unsubstituted ammonium alkylsulfonates, ammonium arylsulfonates, or combinations thereof. In various implementations, an alkyl group of an alkylsulfonate anion is substituted with one or more of halogen, —OR, and —SR, wherein R is hydrogen or a C₁₋₆ alkyl. In some implementations, the ammonium salt is selected from ammonium methanesulfonate, ammonium ethanesulfonate, ammonium propanesulfonate, ammonium butanesulfonate, ammonium trifluoromethanesulfonate, ammonium perfluorobutanesulfonate, ammonium chlorobenzenesulfonate, ammonium p-iodobenzenesulfonate, ammonium benzenesulfonate, ammonium p-toluenesulfonate, ammonium camphorsulfonate, and combinations thereof. Tn ammonium salt can also be selected from ammonium methanesulfonate, ammonium trifluoromethanesulfonate, and ammonium perfluorobutanesulfonate. The ammonium salt can also include anions of formate, citrate, oxalate, ascorbate, acetate, trifluoroacetate, or other carboxylates.

In some implementations, the amount or concentration of acid-generating material, e.g., degradable polymeric materials, esters, or ammonium salts, to specify to include in the reactive treatment fluid is correlative with the amount or concentration of the target component, e.g., inorganic salts, in the filter cake.

### Inverting Surfactant for Reactive Treatment Fluid

In various implementations, the VES-based reactive treatment fluid can further include an inverting surfactant encapsulated in a degradable material. This addition can be particularly useful in addressing the difficulty of removing the oil-based filter cake, for example, where it is difficult to use a mutual solvent that can dissolve oil and the filter cake. In some implementations, the degradable material encapsulating the inverting surfactant degrades at the wellbore temperature and releases the inverting surfactant. Subsequently, the inverting surfactant can invert the oil-based filter cake formed by OBDF to enhance its miscibility or solubility in the aqueous phase of the fluid, thereby promoting the breakage of the filter cake. In some implementations, the inverting surfactant has a hydrophile-lipophile balance (HLB) of at least about 12. In some implementations, the inverting surfactant has a HLB of from 8 to 15, e.g., from 12 to 15. In one implementation, the HLB is higher than 15. The HLB range is provided by surfactants that form oil-in-water emulsion. Examples of the inverting surfactants include alkyl alcohol ethoxylates with a HLB greater than 12 such as TERGITOL™ 15-S-7, TERGITOL™ 15-s-9, TERGITOL™ 15-s-12, PEG 40 stearate, cetearyl glucoside, sodium dodecyl sulfate, sodium dodecylbenzene sulfonate, pluronic L64, dodecyltriemthylammonium chloride (DTAC), alkyltrimethylammonium bromide (ATAB), dimethyldioctadecylammonium chloride (DDOAC), alkyl betaines, and fatty esters.

### Other Additives for Reactive Treatment Fluid

In various implementations, the VES-based reactive treatment fluid contains one or more additives except the VES, the reactive breaker, and the acid-generating materials. For example, the fluid can contain monovalent or divalent salts at a concentration in a range of 0 wt. % to about 50 wt. %, in a range of about 1 wt. % to about 50 wt. %, in a range of 0 wt. % to about 15 wt. %, in a range of about 1 wt. % to about 15 wt. %, or less than about 15 wt. %. These salts can promote micelle formation, such as wormlike or cylindrical micelles, to increase viscosity of the fluid. Examples of these salts include lithium fluoride (LiF), sodium fluoride (NaF), potassium fluoride (KF), magnesium fluoride (MgF₂), calcium fluoride (CaF₂), strontium fluoride (SrF₂), barium fluoride (BaF₂), lithium chloride (LiCl), sodium chloride (NaCl), potassium chloride (KCl), magnesium chloride (MgCl₂), calcium chloride (CaCl₂)), strontium chloride (SrCl₂), barium chloride (BaCl₂), lithium bromide (LiBr), sodium bromide (NaBr), potassium bromide (KBr), magnesium bromide (MgBr₂), calcium bromide (CaBr₂), strontium bromide (SrBr₂), and barium bromide (BaBr₂). Certain salts, such as LiBr salts, can be particularly beneficial for delaying the oxidation of ammonium by bromate and, hence, delaying the formation of acid. This delaying feature can be useful for filter cake cleanup where it is desirable to place the VES-based reactive treatment fluid before it starts to react with the filter cake.

The inorganic oxidizer salt, e.g., as the reactive breaker, and these monovalent or divalent salts can be both effective in micelle formation. Therefore, in some implementations, the combined concentration of the inorganic oxidizer salt and the monovalent or divalent salt in the fluid can be controlled to provide the optical fluid performance. In some implementations, the combined concentration is at least 1 wt. %, at least 3 wt. %, at least 5 wt. %, at least 7 wt. %, at least 10 wt. %, or at least 12 wt. %, or at least 15 wt. %.

Further, the VES-based reactive treatment fluid can contain other organic compounds, such as phthalic acid, salicylic acid, or their salts. The salicylate or other ion in the presence of the surfactant may cause the viscoelastic gel to form. In some implementations, the acid (nonionic) form of these compounds causes the viscoelasticity development to be delayed until the pH is altered, e.g., raised, and the anion is released. For example, the pH may be raised by adding urea that is hydrolyzed as the solution starts to heat after pumping into the wellbore and formation. This is a way of imparting some control over when the viscoelasticity develops. In some cases, carboxylic acid and the hydroxyl (OH) group in salicylic acid interacts with the quaternary ammonium group of the VES and acts as a crosslinker to link and make the micelles more robust. This aids formation of stable micelles and thus stable viscosity at formation temperatures.

In some implementations, the VES-based reactive treatment fluid further contains nanoparticles, e.g., silica, zirconium, or titanium nanoparticles, which can crosslink the micelles and improve the viscosity. Further, other additives can include organophilic clays and nanoclays that impart favorable electrostatic interactions, e.g., hydrogen bonding, and provide high viscosity for diversion and/or reduce total volume of the fluid needed in the formation to maintain sufficient viscosity. Other examples of possible additives for the VES-based reactive treatment fluid include buffer, scale inhibitor, biocide, and corrosion inhibitor such as Cronox™ 242, PAEI-100, Basocorr™ PP, or Basocorr™ PM.

In some implementations, the VES-based reactive treatment fluid does not contain non-oxidizing salt, where the concentration of the oxidizing salt sufficiently enhances the viscosity of the fluid. Further, the VES-based reactive treatment fluid may need not contain an internal breaker, where the oxidizing salt can act as the reactive breaker, which can advantageously reduce the operational complexity. In some implementations, the VES-based reactive treatment fluid also contains polymers such as polysaccharides, e.g., 2-hydroxyethyl cellulose (HEC), Guar, and carboxymethyl cellulose (CMC), and synthetic polymers, e.g., polyacrylamide, its copolymers, and polypyralladone to enhance the viscosity.

Filter Cake Removal with the VES-Based Reactive Treatment Fluid

In various implementations, the process of filter cake removal includes injecting the VES-based reactive treatment fluid into the wellbore that contains the filter cake. In some implementations, the filter cake removal can further include injecting another treatment fluid simultaneously or separately. In other words, the VES-based reactive treatment fluid can be pumped alone or in tandem with other fluids. In some implementations, the injection volume for the VES-based reactive treatment fluid per well is from 30 barrels (4.8 m³) to 100 barrels (15.9 m³), e.g., from 50 barrels (7.9 m³) to 100 barrels (15.9 m³), or from 30 barrels (4.8 m³) to 50 barrels (7.9 m³). The injection pressure can be from 1000 psi (6.9 MPa) to 6000 psi (41.4 MPa), e.g., from 2000 psi (13.8 MPa) to 6000 psi (41.4 MPa), from 3000 psi (20.7 MPa) to 6000 psi (41.4 MPa), from 4000 psi (27.6 MPa) to 6000 psi (41.4 MPa), from 5000 psi (34.5 MPa) to 6000 psi (41.4 MPa), from 1000 psi (6.9 MPa) to 5000 psi (34.5 MPa), from 1000 psi (6.9 MPa) to 4000 psi (27.6 MPa), from 1000 psi (6.9 MPa) to 3000 psi (20.7 MPa), or from 1000 psi (6.9 MPa) to 2000 psi (13.8 MPa). In one implementation, the process also includes recovering the reactive treatment fluid comprising the barite removed from the wall.

In some implementations, the VES-based reactive treatment fluid is pumped as part of a series of steps for treating the oil-based filter cake. For example, prior to pumping the VES-based reactive treatment fluid, a pretreatment fluid can be pumped to change the wettability of the filter cake from oil-wet to water-wet. In some implementations, the pretreatment fluid contains an inverting surfactant encapsulated in a degradable material. The inverting surfactant can have a HLB of about 12 and higher.

Further, the filter cake removal process can include alternately pumping two or more types of treatment fluids into the wellbore, where one of the fluids is the VES-based reactive treatment fluid. In some implementations, carbon dioxide (CO₂) or a fluid containing CO₂ can be used as a second fluid. The second fluid can, for example, include only CO₂ or a mixture of CO₂ and oxidizers. In some implementations, the injection of CO₂ can enhance the cleanup of oil-based residues from the filter cake. The second fluid can also contain reactive gases. In some implementations, the oxidizing gas includes at least one of chlorine dioxide (ClO₂), chlorine gas (Cl₂), bromine gas (Br₂), fluorine gas (F₂), chlorine monofluoride (ClF), oxygen gas (O₂), ozone (O₃), nitrous oxide (N₂O), nitric oxide (NO), or nitrogen dioxide (NO₂). These gases can be dissolved directly in the CO₂ or generated in situ by combining chemical precursors in the treatment fluid. For example, ozone (O₃) can be generated on site from pure oxygen gas or from air. The O₃ can then be injected directly into the CO₂. Similarly, chlorine dioxide (ClO₂) can be generated on-site with commercially available equipment, mixed with air, and added directly to the CO₂ via an oxidizing gas stream. In some implementations, the second fluid is capable of forming foams in the wellbore, reacting to generate halogens, or both.

FIG. 9 is an example process flow diagrams of processes of filter cake removal in accordance with an implementation. A process 900 starts with drilling 902 a wellbore in a subterranean formation using an oil-based drilling fluid (OBDF) including an oil, a synthetic polymer, a barite, forming a filter cake on a wall of the wellbore. The filter cake includes the oil, the synthetic polymer, and the barite. The wellbore has a horizontal portion. Subsequently, the filter cake removal can be performed by providing 904 a reactive treatment fluid into the wellbore to remove the filter cake from the wall, where the reactive treatment fluid includes a viscoelastic surfactant (VES) to gel the reactive treatment fluid to give the reactive treatment fluid as a VES gel, a reactive breaker comprising an oxidizing salt to break the synthetic polymer, and an acid-generating material to form acid.

### Examples

In accordance with an implementation, two sets of example VES-based reactive treatment fluid were prepared and tested for their performance in dissolving oil-based filter cake samples. In the first set, the effect of the presence of a VES in the reactive treatment fluid was example. In the second set, various compositions of the VES-based reactive treatment fluid were compared.

In the first set of experiments, oil-based drilling fluid (OBDF) was prepared with the following components: 54 vol. % diesel, 10⁻¹⁴ parts per billion (ppb) emulsifier (polyaminated fatty acids), 4-6 ppb calcium hydroxide (Ca(OH)₂), 3-6 ppb filtration control agent, 0.5 ppb viscosifier (modified fatty acid), 2-4 ppb organophilic clay, 2-6 ppb 1-5% quartz and other silicates, 17 vol. % water, 10 ppb calcium chloride (CaCl₂)), 10 ppb 25 μm calcium carbonate (CaCO₃), 10 ppb 50 μm CaCO₃, 5 ppb 50 μm graphite, 5 ppb 100 μm graphite, 255 ppb barite (BaSO₄). A 50 mL of the OBDF was placed in the cell of an OFI Testing Equipment, Inc. filter press. A ceramic filter disc was added, and the cell was sealed and placed in the filter press. After heating to 250° F. (121° C.) at 500 psi for 3 hours, the back pressure was released, and fluid was allowed to pass through the filter producing a solid cake composed of the slurry components. The filter cake was divided into sections of about 2 g each and used for 4 dissolution tests.

The first set of dissolution tests were performed by combining about 2 g of the prepared oil-based filter cake with 20 mL of a reactive treatment fluid in a 120-mL glass pressure tube. Tests 1-2 were performed with a VES-containing composition: 8 vol. % Armovis® EHS surfactant, 5 g ammonium chloride (NH₄Cl), and 4.5 g sodium bromate (NaBrO₃). Tests 3-4 were performed as a reference without any VES, using a second composition: 5 g NH₄Cl and 4.5 g NaBrO₃.

The mixtures were heated for a duration of 6 hours at 250° F. (121° C.) under ambient pressure, and the results are shown in FIG. 10. Top row shows the four sample before the heating, while the bottom row shows them after the heating. After the heating, the solution changed from colorless to orange in color. Tests 1-2 show a good dispersion of the oil-based filter cake in the solution, while the filter cake remained coagulated in the bottom of the tube in Tests 3-4. Filtration of the samples after the heating and weighing the residual filter cake collected on filter paper indicated that the filter cake had degraded by the following quantities: 35% (Test 1), 34% (Test 2), 7% (Test 3), 10% (Test 4). These results demonstrate that the effective removal of oil-based filter cake can be enabled by the addition of a VES to the fluid containing the oxidizing salt and acid-generating material.

In the second set of experiments, OBDF and the oil-based filter cake were prepared with the same procedures described above for the first set of experiments. Dissolution tests were performed by combining about 2 g of the oil-based filter cake with 20 mL of the VES-based reactive treatment fluid with six different compositions. Tests 1-6 were performed with 2-8 vol. % Armovis® EHS surfactant, 0-5 g NH₄Cl, and 6.2-8.8 g NaBrO₃. The fluid compositions are summarized in Table 1. The mixtures were heated for 3 hours at 250° F. (121° C.), and the samples were filtered and weighed for the residual filter cake collected on filter paper.

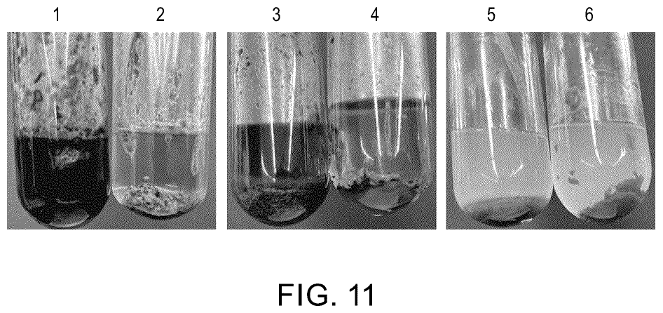

The results are shown in FIG. 11 and Table 1. The tests generally show good dispersion of the oil-based filter cake with the calculated mass loss at least about 24% except Test 4. The best performance was obtained from Test 5, where the fluid contains 8 vol. % Armovis® EHS surfactant, 3.5 g NH₄Cl, and 6.2 g NaBrO₃ in 65 mL water. As shown in Table 1, it was demonstrated that the presence of NH₄Cl, the acid-generating material was essential for the best dissolution performance (Test 3 versus Test 5), while the excess of salts, both NH₄Cl and NaBrO₃, can be detrimental (Test 1 versus Test 5). The trend also shows that a higher VES concentration may generally be favorable in effective dissolution.

TABLE 1
Dissolution test results with different VES-
based reactive treatment fluid compositions

| | | | | | Mass | Mass | |
|---|---|---|---|---|---|---|---|
| Test | NH₄Cl | NaBrO₃ | VES | Water | Before | After | Mass |
| # | (g) | (g) | (vol. %) | (mL) | (g) | (g) | Loss |
| 1 | 5 | 8.8 | 8 | 65 | 1.5 | 1.0 | 34.7% |
| 2 | 5 | 8.8 | 2 | 65 | 1.8 | 1.4 | 25.0% |
| 3 | 0 | 8.8 | 8 | 65 | 2.0 | 1.3 | 36.5% |
| 4 | 0 | 8.8 | 2 | 65 | 1.8 | 1.7 | 5.6% |
| 5 | 3.5 | 6.2 | 8 | 65 | 2.4 | 1.3 | 45.4% |
| 6 | 3.5 | 6.2 | 2 | 65 | 2.3 | 1.7 | 24.8% |

Further experiments were conducted to study the effects of adding strong oxidizing salts, in-situ acid, and a delay agent on fluid rheology. Three compositions were prepared to contain 8 vol. % Armovis® EHS with different additives as follows: (1) with NaBrO₃ oxidizing salt only; (2) with NaBrO₃ oxidizing salt and NH₄Cl acid-generating agent; and (3) with NaBrO₃ oxidizing salt, NH₄Cl acid-generating agent, and LiBr delay agent. The compositions are also summarized in Table 2. The fluids were prepared by first dissolving the salt(s) in 130 mL water. Subsequently, the VES was added, and the solution agitated to ensure the mixing. After each fluid was prepared, the viscosity was measured with a rheometer as a function of temperature.

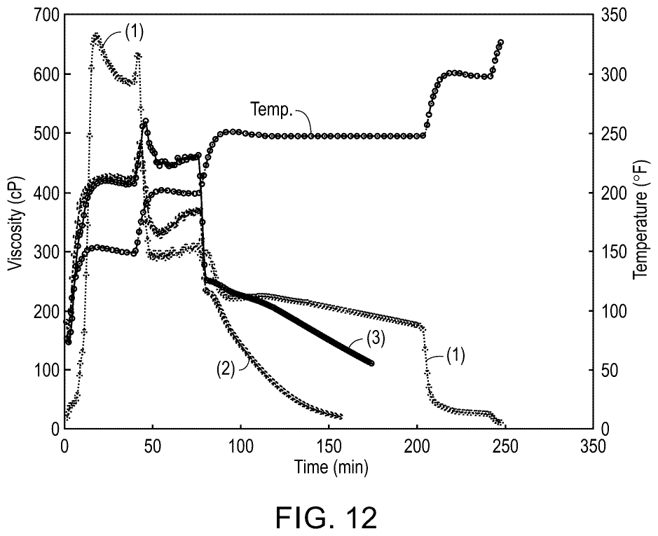

FIG. 12 is a plot of rheological profiles for the three compositions. The temperature was initially ramped to 150° F. (66° C.) and held until the viscosity stabilized. As the temperature was further ramped to 200° F. (93° C.) and then 250° F. (121° C.), the viscosity of the fluids dropped to about 200-300 cP for all three compositions. For the fluid with oxidizer only (1), the viscosity remained stable at about 200-250 cP while holding the temperature at 250° F. (121° C.) for 2 hours. The fluid with oxidizer and in situ acid (2) showed steady viscosity drop over about 1 hour. This continuous viscosity drop supports the in-situ acid generation from the acid-generating agent due to heat and the generated acid lowing the viscosity, confirming the benefit of the in-situ acid to provide the capability of viscosity control of the reactive treatment fluid in the formation. The fluid with oxidizer, in situ acid, and delay agent (3) showed a drop in viscosity over an hour and a half, but at a slower rate than (2), demonstrating the effect of the delaying agent.

TABLE 2
VES-based reactive treatment fluid compositions

| Test | NH₄Cl | NaBrO₃ | LiBr | VES | Water |
|---|---|---|---|---|---|
| # | (g) | (g) | (g) | (vol. %) | (mL) |
| 1 | 0 | 6.0 | 0 | 8 | 130 |
| 2 | 2.65 | 6.0 | 0 | 8 | 130 |
| 3 | 2.65 | 6.0 | 3.47 | 8 | 130 |

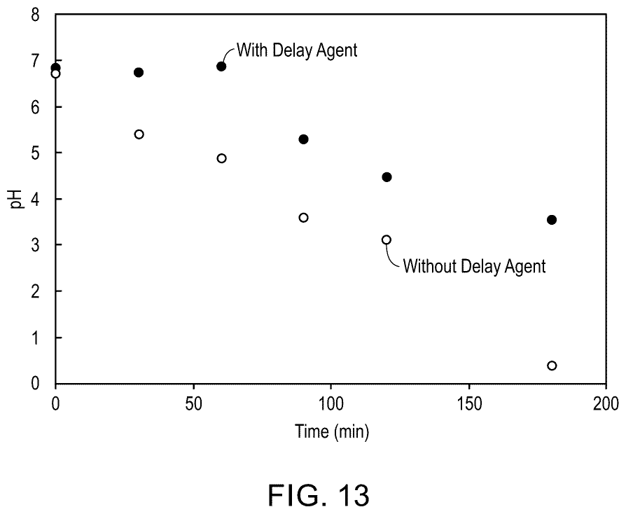

In addition, the rate of acid generation from the acid-generating material was further investigated through experiments. Two fluid compositions were prepared with 8 vol. % Armovis® EHS, 4 g NaBrO₃, and 1.33 g NH₄Cl in 65 mL water. To one of the fluids was added 3.47 g LiBr delay agent. The pH of each composition was measured as a function of time with repeated heating to induce acid release. The initial pH was around 6.7-6.8 for both fluids. The two fluids were then heated to 300° F. (149° C.) for 30 min and the pH was measured for a second data point. After the measurement, the fluids were reheated to and maintained at 300° F. (149° C.) for another 30 min, and the pH was measured for a next data point. This heating-measurement cycle was repeated for 180 min. FIG. 13 is a plot of the measured pH as a function of time. The result shows the slower pH drop in the presence of the delay agent, supporting the role of the delay agent in suppressing the acid generation from the acid-generating material and thereby slowing the viscosity drop demonstrated in the previous experiments (FIG. 12).

### Embodiments

1. A method of treating a wellbore for filter cake removal, the method comprising: injecting a reactive treatment fluid into a wellbore in a subterranean formation comprising a filter cake on a wall of the wellbore, the filter cake comprising an oil, a water-resistant polymer, a barite, and an inorganic salt, the reactive treatment fluid comprising, a viscoelastic surfactant (VES), a reactive breaker comprising an oxidizing salt, and an acid-generating material; and contacting the reactive treatment fluid with the filter cake in the wellbore, the reactive treatment fluid dissolving or exfoliating the barite from the wall into the reactive treatment fluid.
2. The method of embodiment 1, further including, prior to providing the reactive treatment fluid into the wellbore, forming the wellbore by drilling using an oil-based drilling fluid (OBDF) including the oil, the polymer, and the barite, wherein the drilling forms the filter cake in the wellbore.
3. The method of embodiment 1 or 2, further including specifying a concentration of VES, the reactive breaker, or the acid-generating material in the reactive treatment fluid based on a characteristic of the subterranean formation and a design of the wellbore.
4. The method of any one of embodiments 1-3, where the wellbore includes a horizontal portion, and wherein a gelling performance of the VES gel promotes retention of the oxidizing salt in the reactive treatment fluid for breaking the water-resistant polymer in the horizontal portion of the wellbore.
5. The method of any one of embodiments 1-4, where the oil includes diesel oil or palm oil.
6. The method of any one of embodiments 1-5, where the water-resistant polymer includes ethylene-propylene polymer, maleated polymer, organophilic clay, or poly-a-olefins.
7. The method of any one of embodiments 1-6, where the inorganic salt includes calcium carbonate, bentonite, barite, ilmenite, hematite, or manganese tetroxide.
8. The method of any one of embodiments 1-7, where the reactive treatment fluid includes an inverting surfactant encapsulated in an encapsulating material that degrades at a temperature of the subterranean formation.
9. The method of embodiment 8, further including: degrading the encapsulating material to release the inverting surfactant; and inverting the filter cake with the inverting surfactant, wherein the inverting surfactant includes an hydrophile-lipophile balance (HLB) of at least 12.
10. A method of treating a wellbore, the method including: drilling a wellbore in a subterranean formation using an oil-based drilling fluid (OBDF) including an oil, a synthetic polymer, a barite, forming a filter cake on a wall of the wellbore, the filter cake including the oil, the synthetic polymer, and the barite, the wellbore having a horizontal portion; and performing a filter cake removal process including providing a reactive treatment fluid into the wellbore to remove the filter cake from the wall, the reactive treatment fluid including, a viscoelastic surfactant (VES) to gel the reactive treatment fluid to give the reactive treatment fluid as a VES gel, a reactive breaker including an oxidizing salt to break the synthetic polymer, and an acid-generating material to form acid.
11. The method of embodiment 10, where a gelling performance of the VES gel promotes retention of the oxidizing salt in the reactive treatment fluid for breaking the synthetic polymer in the horizontal portion of the wellbore.
12. The method of embodiment 10 or 11, the filter cake removal process further including providing carbon dioxide (CO₂) into the wellbore.
13. The method of embodiment 12, where the CO₂ is provided simultaneously with the reactive treatment fluid.
14. The method of any one of embodiments 10⁻¹³, the filter cake removal process further including providing a second fluid including carbon dioxide (CO₂) into the wellbore.
15. The method of embodiment 14, the filter cake removal process further including alternately repeating the step of providing the reactive treatment fluid and the step of providing the second fluid.
16. The method of embodiment 14 or 15, where the second fluid further includes an oxidizer.
17. A method of treating a wellbore for filter cake removal, the method including: providing a reactive treatment fluid into a wellbore in a subterranean formation including a filter cake on a wall of the wellbore, the filter cake including an oil, a water-resistant polymer, a barite, and an inorganic salt, the reactive treatment fluid including, a viscoelastic surfactant (VES), the VES being 0.1 to 10 wt. % of the reactive treatment fluid; a reactive breaker including a bromate, and ammonium halide; and dissolving or exfoliating the barite from the wall into the reactive treatment fluid.
18. The method of embodiment 17, where the bromate is sodium bromate (NaBrO₃) and the ammonium halide is ammonium chloride (NH₄Cl).
19. The method of embodiment 17 or 18, where the oil includes diesel oil or palm oil, wherein the water-resistant polymer includes ethylene-propylene polymer, maleated polymer, organophilic clay, or poly-a-olefins, and wherein the inorganic salt includes calcium carbonate.
20. The method of any one of embodiments 17-19, further including foaming the reactive treatment fluid with carbon dioxide (CO₂).

What is claimed is:

1. A method of treating a wellbore for filter cake removal, the method comprising:
injecting a reactive treatment fluid into a wellbore in a subterranean formation comprising a filter cake on a wall of the wellbore, the filter cake comprising an oil, a water-resistant polymer, a barite, and an inorganic salt, the reactive treatment fluid comprising,
a viscoelastic surfactant (VES),
a reactive breaker comprising an oxidizing salt, and
an acid-generating material; and
contacting the reactive treatment fluid with the filter cake in the wellbore, the reactive treatment fluid dissolving or exfoliating the barite from the wall into the reactive treatment fluid.

2. The method of claim 1, further comprising, prior to providing the reactive treatment fluid into the wellbore, forming the wellbore by drilling using an oil-based drilling fluid (OBDF) comprising the oil, the polymer, and the barite, wherein the drilling forms the filter cake in the wellbore.

3. The method of claim 1, further comprising specifying a concentration of VES, the reactive breaker, or the acid-generating material in the reactive treatment fluid based on a characteristic of the subterranean formation and a design of the wellbore.

4. The method of claim 1, wherein the wellbore comprises a horizontal portion, and wherein a gelling performance of the VES gel promotes retention of the oxidizing salt in the reactive treatment fluid for breaking the water-resistant polymer in the horizontal portion of the wellbore.

5. The method of claim 1, wherein the oil comprises diesel oil or palm oil.

6. The method of claim 1, wherein the water-resistant polymer comprises ethylene-propylene polymer, maleated polymer, organophilic clay, or poly-a-olefins.

7. The method of claim 1, wherein the inorganic salt comprises calcium carbonate, bentonite, barite, ilmenite, hematite, or manganese tetroxide.

8. The method of claim 1, wherein the reactive treatment fluid comprises an inverting surfactant encapsulated in an encapsulating material that degrades at a temperature of the subterranean formation.

9. The method of claim 8, further comprising:
degrading the encapsulating material to release the inverting surfactant; and
inverting the filter cake with the inverting surfactant, wherein the inverting surfactant comprises an hydrophile-lipophile balance (HLB) of at least 12.

10. A method of treating a wellbore, the method comprising:
drilling a wellbore in a subterranean formation using an oil-based drilling fluid (OBDF) comprising an oil, a synthetic polymer, a barite, forming a filter cake on a wall of the wellbore, the filter cake comprising the oil, the synthetic polymer, and the barite, the wellbore having a horizontal portion; and
performing a filter cake removal process comprising providing a reactive treatment fluid into the wellbore to remove the filter cake from the wall,
the reactive treatment fluid comprising,
a viscoelastic surfactant (VES) to gel the reactive treatment fluid to give the reactive treatment fluid as a VES gel,
a reactive breaker comprising an oxidizing salt to break the synthetic polymer, and
an acid-generating material to form acid.

11. The method of claim 10, wherein a gelling performance of the VES gel promotes retention of the oxidizing salt in the reactive treatment fluid for breaking the synthetic polymer in the horizontal portion of the wellbore.

12. The method of claim 10, the filter cake removal process further comprising providing carbon dioxide (CO₂) into the wellbore.

13. The method of claim 12, wherein the CO₂ is provided simultaneously with the reactive treatment fluid.

14. The method of claim 10, the filter cake removal process further comprising providing a second fluid comprising carbon dioxide (CO₂) into the wellbore.

15. The method of claim 14, the filter cake removal process further comprising alternately repeating the step of providing the reactive treatment fluid and the step of providing the second fluid.

16. The method of claim 14, wherein the second fluid further comprises an oxidizer.

17. A method of treating a wellbore for filter cake removal, the method comprising:
providing a reactive treatment fluid into a wellbore in a subterranean formation comprising a filter cake on a wall of the wellbore, the filter cake comprising an oil, a water-resistant polymer, a barite, and an inorganic salt, the reactive treatment fluid comprising,
a viscoelastic surfactant (VES), the VES being 0.1 to 10 wt. % of the reactive treatment fluid;
a reactive breaker comprising a bromate, and
ammonium halide; and
dissolving or exfoliating the barite from the wall into the reactive treatment fluid.

18. The method of claim 17, wherein the bromate is sodium bromate (NaBrO₃) and the ammonium halide is ammonium chloride (NH₄Cl).

19. The method of claim 17, wherein the oil comprises diesel oil or palm oil, wherein the water-resistant polymer comprises ethylene-propylene polymer, maleated polymer, organophilic clay, or poly-a-olefins, and wherein the inorganic salt comprises calcium carbonate.

20. The method of claim 17, further comprising foaming the reactive treatment fluid with carbon dioxide (CO₂).
